(19) United States
(12) Patent Application Publication
(10) Pub. No.: US 2026/0320750 A1
(43) Pub. Date: Oct. 15, 2026

(54) SYSTEMS AND METHODS FOR THERMAL IMAGING ENHANCEMENT

(71) Applicant: Rivet Industries, Inc., Washington, DC (US)

(72) Inventors: Seyedsohrab MADANI, Menlo Park, CA (US); Afshin A. ZADE, Menlo Park, CA (US); Sean F. ONG, Port Orchard, WA (US); Jouya JADIDIAN, Los Gatos, CA (US); Mohit NARANG, Cupertino, CA (US)

(21) Appl. No.: 19/643,413

(22) Filed: Apr. 9, 2026

Related U.S. Application Data
(60) Provisional application No. 63/789,208, filed on Apr. 15, 2025.

(51) Int. Cl. G06T 5/50; G06T 5/77; G06T 7/00

(52) U.S. Cl. CPC G06T 5/50; G06T 5/77; G06T 7/0002; G06T 2207/10048; G06T 2207/20004; G06T 2207/20084; G06T 2207/20212; G06T 2207/30168

(57) ABSTRACT

In an embodiment, a standard deviation associated with a thermal image of a scene is determined. A threshold is determined based on the standard deviation. An output range adjustment is determined based on the threshold. Output range boundaries are set based on the output range adjustment. Adaptive percentile thresholds are determined based on the threshold. The thermal image is normalized based on the output range boundaries and the adaptive percentile thresholds to generate an updated thermal image. An object is detected at the scene based on the updated thermal image and not the thermal image.

### CROSS-REFERENCE TO RELATED APPLICATION

This application claims priority to U.S. Provisional Patent Application No. 63/789,208, filed Apr. 15, 2025 and titled “SYSTEMS AND METHODS FOR THERMAL IMAGING ENHANCEMENT,” the contents of which are incorporated by reference herein in its entirety.

### FIELD

One or more embodiments relate to systems and methods for thermal imaging enhancement.

### BACKGROUND

Thermal image enhancement aims to improve the clarity, contrast, and interpretability of infrared images, particularly in low-contrast or noisy environments. Known techniques, however, are often unsatisfactory in preserving fine details, adapting to varying thermal scenes, and enhancing images without introducing artifacts. These limitations can hinder accurate analysis in applications such as surveillance, diagnostics, and autonomous systems.

### SUMMARY

In an embodiment, a standard deviation associated with a thermal image of a scene is determined. A threshold is determined based on the standard deviation. An output range adjustment is determined based on the threshold. Output range boundaries are set based on the output range adjustment. Adaptive percentile thresholds are determined based on the threshold. The thermal image is normalized based on the output range boundaries and the adaptive percentile thresholds to generate an updated thermal image. An object is detected at the scene based on the updated thermal image and not the thermal image.

### BRIEF DESCRIPTION OF THE DRAWINGS

FIG. 1 illustrates a block diagram of a compute device configured to generate an enhanced thermal image, according to an embodiment.

FIG. 2 illustrates a flowchart of a method to generate an enhanced thermal image, according to an embodiment.

FIG. 3 illustrates a comparison of four different example thermal images.

FIG. 4 illustrates percentile ranges and thresholds for example scenes with differing levels of complexity, according to an embodiment.

FIG. 5 illustrates a system block diagram of a helmet mounted display (HMD), according to an embodiment.

FIG. 6 illustrates a method to generate an updated thermal image, according to an embodiment.

FIG. 7 illustrates a method to display an updated thermal image, according to an embodiment.

FIG. 8 illustrates a method to generate updated thermal images, according to an embodiment.

### DETAILED DESCRIPTION

Thermal cameras can capture a broad range of numerical values that correspond to varying levels of infrared radiation. Each pixel in a thermal image can be assigned a numerical value that represents the intensity of infrared radiation detected at that pixel. This numerical value can be directly correlated to the temperature of the object being imaged. For example, a thermal camera can use a 16-bit resolution, allowing each pixel to be represented by a value ranging from 0 to 65,535. This range defines the camera's capability to measure infrared radiation levels across diverse temperatures.

In most scenarios, however, the temperature range within the scene being captured is typically narrower than the camera's full dynamic range. As a result, the pixel values used to represent the scene usually occupy only a subset of the camera's entire numerical range. For instance, while a thermal camera may support the numerical range of 0 to 65,535, the temperatures in a specific scene might only span a range equivalent to pixel values between 5,000 and 7,000. Consequently, values outside this subset (e.g., 0 to 4,999 and 7,001 to 65,535) would remain unused for that particular scene.

Thermal data normalization can enhance representation; known techniques, however, face notable limitations. For instance, sensitivity to outliers often compresses the meaningful range due to extreme numerical values. Similarly, global normalization fails to provide adequate local contrast within individual images. Additionally, temporal inconsistencies can result in the same object appearing with varying brightness across frames. Consequently, these shortcomings in known methods can degrade image quality, hinder object recognition, and impair the effectiveness of the analysis of thermal images.

As such, some embodiments described herein are related to a compute device that can perform adaptive scene-aware thermal image enhancement. Unlike known approaches to thermal image enhancement, the compute device can adapt to scene complexity and thermal distributions to produce consistent, high-contrast thermal imagery without artificial brightness fluctuations. In some implementations, the compute device dynamically adjusts normalization

parameters based on scene complexity. Thus, the normalization parameters used at a first scene with a first complexity can be different than the normalization parameters used at a second scene (different than the first scene) with a second complexity (different than the first complexity). In some implementations, scene complexity is determined based on standard deviation of pixel values. Scene complexity can be normalized against a predetermined threshold, then later used to generate a normalized image.

In some implementations, the compute device eliminates (or at least reduces) outlier influence through adaptive percentile thresholding. For example, rather than using a minimum and maximum value from an image (which could be outliers), percentile-based thresholds can be used. In some implementations, and as further discussed herein, a percentile low threshold (P_{low}) and a percentile high threshold (P_{high}) are determined for a given image and used to normalize that image. The percentile boundaries (P_{low} and P_{high}) can be dynamically adjusted based on scene complexity. For example, the p_{low} and p_{high} values used to normalize an image of a first scene can be different than the p_{low} and p_{high} values used to normalize an image of a second scene different than the first scene.

In some implementations, object appearance (e.g., color and/or shape) can remain substantially (e.g., within 1%, within 5%, within 10%) consistent across multiple frames despite scene changes. Said differently, despite receiving multiple different images, the adaptive techniques described herein can be applied for each of those images to generate multiple enhanced thermal images that maintain object appearance across those multiple enhanced thermal images. For example, for a camera tracking a person walking across a landscape, the rest of the scene (e.g., background and foreground) will change as the person moves. If the person is walking towards the camera, the person will likely appear to have a higher detected thermal intensity. The image can be adaptively modified so that the person appears to have a substantially consistent appearance, such as shape (other than increasing in size due to proximity) and color (even though the person's detected thermal intensity would otherwise increase).

In some implementations, the compute device enhances local contrast while preserving global thermal relationships (e.g., using contrast-limited adaptive histogram equalization (CLAHE)). In some implementations, local contrast enhancement includes designating and/or defining image sub-portions (e.g., tiles) across images for localized processing. In some implementations, visualization is improved (e.g., optimized) based on thermal distribution characteristics.

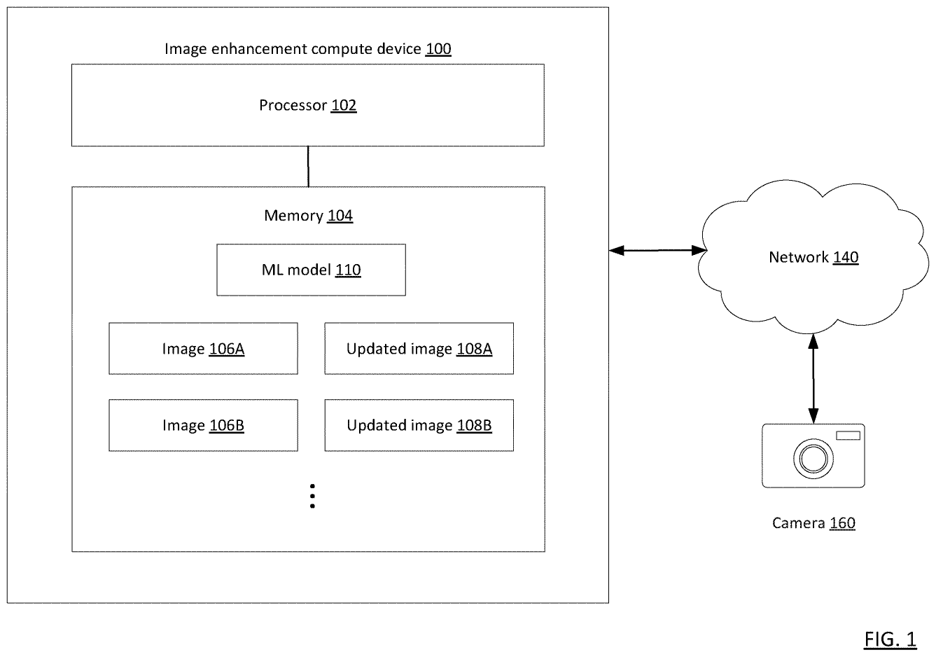

FIG. 1 illustrates a block diagram of a compute device configured to generate an enhanced thermal image, according to an embodiment. FIG. 1 includes image enhancement compute device 100 operatively coupled to camera 160 via network 140.

Network 140 can be any suitable communications network for transferring data, operating over public and/or private communications networks. For example, network 140 can include a private network, a Virtual Private Network (VPN), a Multiprotocol Label Switching (MPLS) circuit, the Internet, an intranet, a local area network (LAN), a wide area network (WAN), a metropolitan area network (MAN), a worldwide interoperability for microwave access network (WiMAX®), an optical fiber (or fiber optic)-based network, a Bluetooth® network, a virtual network, and/or any combination thereof. In some instances, network 140 can be a wireless network such as, for example, a Wi-Fi or wireless local area network (“WLAN”), a wireless wide area network (“WWAN”), and/or a cellular network. In other instances, the network 140 can be a wired network such as, for example, an Ethernet network, a digital subscription line (“DSL”) network, a broadband network, and/or a fiber-optic network. The communications sent via network 140 can be encrypted or unencrypted. In some instances, network 140 can include multiple networks or subnetworks operatively coupled to one another by, for example, network bridges, routers, switches, gateways and/or the like.

Camera 160 is an image acquisition device configured to capture visual information from a scene. Camera 160 can include one or more image sensors, optical elements (such as lenses or filters), processing circuitry, and associated housing components. The image sensors may be of various types, including but not limited to complementary metal-oxide-semiconductor (CMOS) sensors or charge-coupled device (CCD) sensors. Although not shown in FIG. 1, camera 160 can include a processor operatively coupled to a memory (e.g., via a system bus).

In some implementations, camera 160 is thermal camera that includes an imaging system configured to detect infrared radiation (e.g., in the long-wave infrared (LWIR) spectrum) and generate thermal data representing thermal characteristics of a scene. Camera 160 can include a thermal sensor array or matrix configured to capture spatial variations in emitted infrared energy.

Image enhancement compute device 100 can be any type of compute device (e.g., server, desktop, laptop, tablet, phone, edge device, and/or the like). Image enhancement compute device 100 includes processor 102 operatively coupled to memory 104 (e.g., via a system bus).

Processor 102 can be, for example, a hardware-based integrated circuit (IC) or any other suitable processing device configured to run or execute a set of instructions or a set of codes. For example, processor 102 can include a general purpose processor, a central processing unit (CPU), an accelerated processing unit (APU), an application specific integrated circuit (ASIC), a field programmable gate array (FPGA), a programmable logic array (PLA), a complex programmable logic device (CPLD), a programmable logic controller (PLC), a graphics processing unit (GPU), a neural network processor (NNP), and/or the like. Processor 102 can be operatively coupled to memory 104 through a system bus (for example, address bus, data bus, and/or control bus). Memory 104 can store electronic information. The term memory may refer to various types of processor-readable media such as, for example, random access memory (RAM), read-only memory (ROM), non-volatile random access memory (NVRAM), programmable read-only memory (PROM), erasable programmable read only memory (EPROM), electrically erasable PROM (EEPROM), flash memory, magnetic or optical data storage, registers, etc.

Image enhancement compute device 100 can receive images (e.g., image 106A, 106B, etc.) captured by camera 160. Camera 160 can capture images of a scene(s) and send an electronic signal representing those images to image enhancement compute device 100 via network 140. Although some examples describe images, it can be appreciated that a multiple images can make up a video/video stream. Image 106A and image 106B can be of the same scene (e.g., different frames of a video stream of the same scene) or of different scenes.

Image enhancement compute device 100 is configured to generate updated image 108A based on image 106A, generate updated image 108B based on image 106B, etc. Said differently, in response to receiving an image (e.g., captured by camera 160), image enhancement compute device 100 can generate an updated version of that image. Regardless of whether image 106A or 106B is of a simple scene or complex scene, updated images 108A and 108B can have enhanced contrast and eliminate brightness artifacts otherwise caused from outliers.

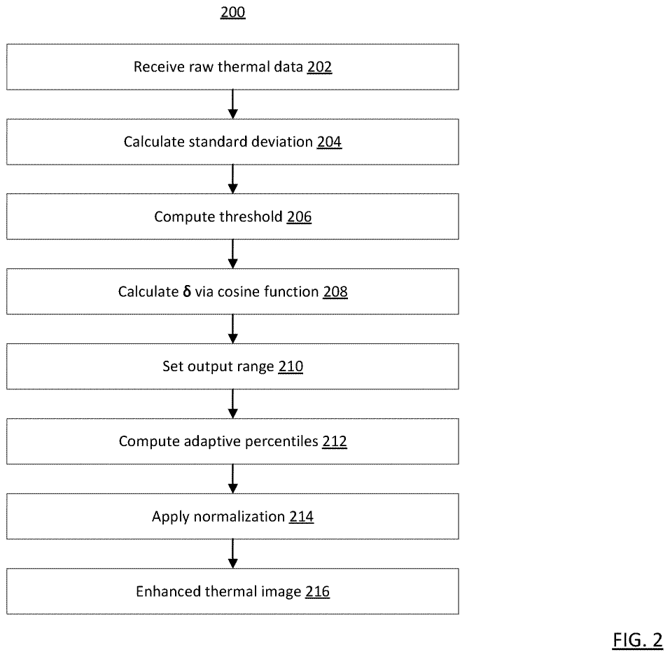

Image enhancement compute device 100 can generate the updated images using, for example, method 200 discussed with respect to FIG. 2. For example, method 200 can be applied to image 106A to generate updated image 108A, method 200 can be applied to image 106B to generate updated image 108B, etc.

In some implementations, updated images 108A and 108B are displayed (e.g., at image enhancement compute device 100, camera 160, and/or a compute device not shown in FIG. 1) instead of or in addition to image 106A and 106B. In some implementations, updated images 108A and 108B are displayed at a helmet mounted display (HMD), such as the helmet mounted display disclosed in U.S. patent application Ser. No. 19/072,793 and/or Ser. No. 19/049,754.

Memory 104 of image enhancement compute device 100 further includes (e.g., stores) machine learning (ML) model 110. ML model 110 can be, for example, a deep learning model based on a convolutional neural network (CNN), a region-based convolutional neural network (R-CNN), or a single shot multibox detector (SSD)) configured to detect objects from images. In some implementations, ML model 110 receives updated images 108A and 108B (instead of images 106A and 106B) as input to detect those objects. By using updated images 108A and 108B instead of images 106A and 106B, ML model 110 can detect objects that ML model 110 would not otherwise have detected.

Although FIG. 1 illustrates a single camera, in some implementations, image enhancement compute device 100 can receive images from multiple different cameras at multiple different locations. In response to receiving those images, image enhancement compute device 100 can generate updated images and send those updated images back to the respective cameras.

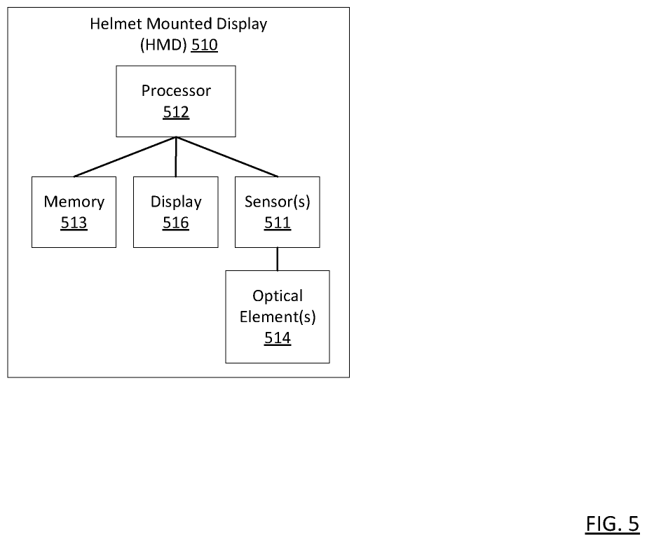

Although FIG. 1 illustrates camera 160 separate from image enhancement compute device 100, in some implementations, the functions of image enhancement compute device 100 can be performed in a single compute device. That is, a single device can both capture images (e.g., image 106A, 106B, etc.) and process those images to generate updated images (e.g., updated image 108A, 108B, etc.). In some implementations, the single device is an HMD. FIG. 5 illustrates a system block diagram of an HMD, according to an embodiment, and is discussed in more detail below. The HMD can include a camera (e.g., camera 160), a display (e.g., configured to display updated images 108A and 108B but not display images 106A and 106B), and circuitry (e.g., a processor and memory) configured to generate updated images 108A and 108B.

Techniques described herein can be applied in various applications. For example, images 106A, 106B, etc. can be images taken while conducting security/surveillance, monitoring industrial processes, performing medical thermal imaging, operating autonomous vehicles, conducting search and rescue missions, monitoring wildlife, and/or the like.

Techniques described herein increase object detectability and reduce false positives in thermal analysis (by human and/or computers). For example, results have shown a 300% improvement in object detectability in low-contrast scenes using an embodiment described herein compared to known methods, and an 85% reduction in false positives from thermal artifacts compared to known methods. In some implementations, rather than analyze images 106A and 106B, updated images 108A and 108B can be analyzed instead. For example, a machine learning model (e.g., a deep learning model based on a convolutional neural network (CNN), a region-based convolutional neural network (R-CNN), or a single shot multibox detector (SSD)) configured to detect objects from images can receive updated images 108A and 108B (instead of images 106A and 106B) as input to detect those object. By using updated images 108A and 108B instead of images 106A and 106B, the machine learning model can detect objects that the machine learning model would not otherwise have detected.

In some implementations, an image is received at image enhancement compute device 100 and the image is divided into multiple sub-images. Those sub-images can be mutually exclusive and/or partially overlap. Rather than apply method 200 (discussed below) to the entire image, method 200 can be applied separately to each of the sub-images to generate multiple enhanced sub-images that can then be put together to form a single enhanced image. For example, where the sub-images are mutually exclusive, the enhanced sub-images can be arranged (e.g., stitched/concatenated/tiled) according to their respective spatial positions within the original image to reconstruct the single enhanced image. Where the sub-images partially overlap, the enhanced sub-images can be combined using blending techniques (e.g., weighted averaging, feathering, or gradient-based blending) in the overlapping regions to produce smooth transitions between adjacent enhanced sub-images in the single enhanced image.

FIG. 2 illustrates a flowchart of a method 200 to generate an enhanced thermal image, according to an embodiment. In some implementations, method 200 is performed by processor 102.

At 202, raw thermal data is received (e.g., representing image 106A or 106B). The raw thermal data can be received at, for example, image enhancement compute device 100 from camera 160.

At 204, a standard deviation (6) of the thermal image is calculated. For example, each pixel in the thermal image can represent a temperature value (or a value proportional to temperature, like infrared intensity), and the standard deviation is calculated to represent how much variation or dispersion exists from the average pixel value.

At 206, a threshold (threshold) is computed. In some implementations, the threshold is calculated using the following

$$threshold = clip ( \frac{σ}{{σ}_{threshold}} , 0.1 )$$

where (1) σ_{threshold} is a predetermined threshold value determined based on σ and (2) clip refers to a function that cuts off values going beyond a predetermined acceptable range (here, values that have an intensity less than 0 and values that have an intensity above 1). Without application of the clip function, if an intensity value at a given pixel is too high or too low, the image at that pixel (and maybe more pixels due to the gain and contrast control) will be saturated to the maximum or minimum value of the applicable color scale (e.g., whited out or blacked out in a grayscale palette, or saturated to the corresponding extreme color in other palettes), respectively. Thus, clip can cap high intensity values going beyond a certain value (e.g., 1) and define a floor for intensity values going below a certain value (e.g., 0). Although 0 is provided as the floor and 1 is provided as the ceiling in the above example, other values can be used in other implementations.

At 208, an output range adjustment (δ) is calculated via a cosine function. In some implementations, the output range adjustment is calculated using the following

δ=cos(π×threshold/2)×coeff
where coeff refers to a scaling value.

At 210, an output range, which includes an output minimum (outₘᵢₙ) and an output maximum (outₘₐₓ), is set. In some implementations, the output range is calculated using the following

outₘᵢₙ=1−δ

outₘₐₓ=8

At 212, adaptive percentiles, which include a percentile low threshold (P_{low}) and a percentile high threshold (P_{high}), are computed. In some implementations, the adaptive percentiles are calculated using the following

P_{low}=percentile(img,2.0−1.5×threshold)

P_{high}=percentile(img,98.0+1.5×threshold)
where percentile is a function that returns a percentile value based on a histogram of img, img represents a two-dimensional array of pixel values of the raw thermal data from 202, 2.0 refers to a static minimum value, 98.0 refers to a static maximum value, and 1.5 refers to a predefined heuristic number. In other implementations, values other than 2.0, 98.0, and 1.5 can be used.

At 214, normalization is applied to generate an enhanced thermal image (normalized) at 216. The normalized image can be, for example, updated image 108A or 108B. In some implementations, the normalized image is generated using the following

$$normalized = \frac{img - {p}_{low}}{{p}_{high} - {p}_{low}} \times ( {out}_{max} - {out}_{min} ) + {out}_{min}$$

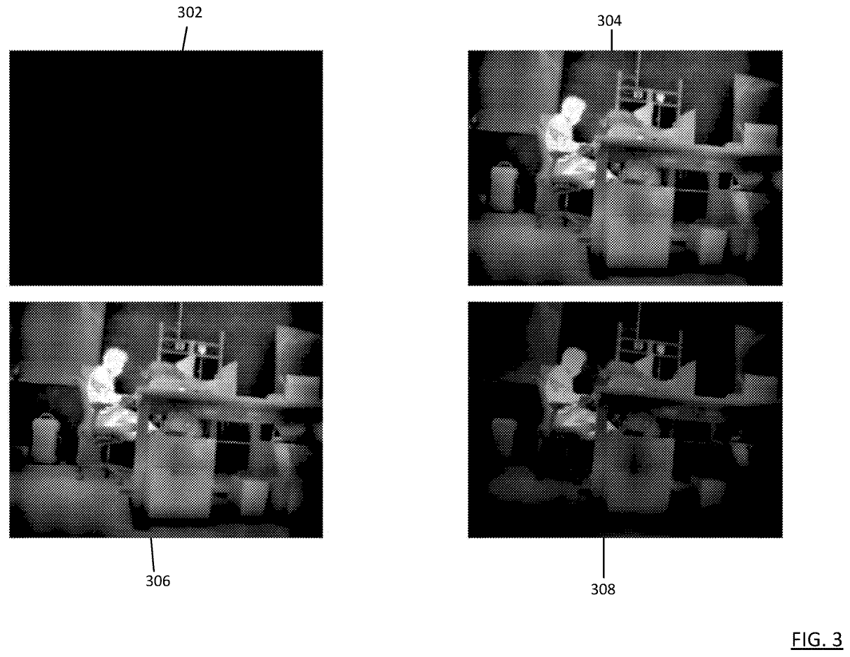

FIG. 3 illustrates a comparison of four different example thermal images. Image 302 illustrates a raw thermal image (e.g., image 106A or 106B). Images 304 and 306 illustrate thermal images generated based on image 302 and normalized using known techniques. Image 308 illustrates a thermal image (e.g., updated image 108A or 108B) generated based on image 302 and normalized using techniques described herein. As illustrated, the color differences and brightness are smoother and less dramatic at image 308 compared to images 304 and 306. In the context of object detection by a machine learning model, smoother thermal images help reduce noise and irrelevant variability, allowing the machine learning model to more effectively process meaningful features and patterns. Overly enhanced or highly contrasted images can exaggerate minor differences, introduce artifacts, or obscure subtle thermal signatures, leading to decreased accuracy, overfitting, or misclassification by the machine learning model.

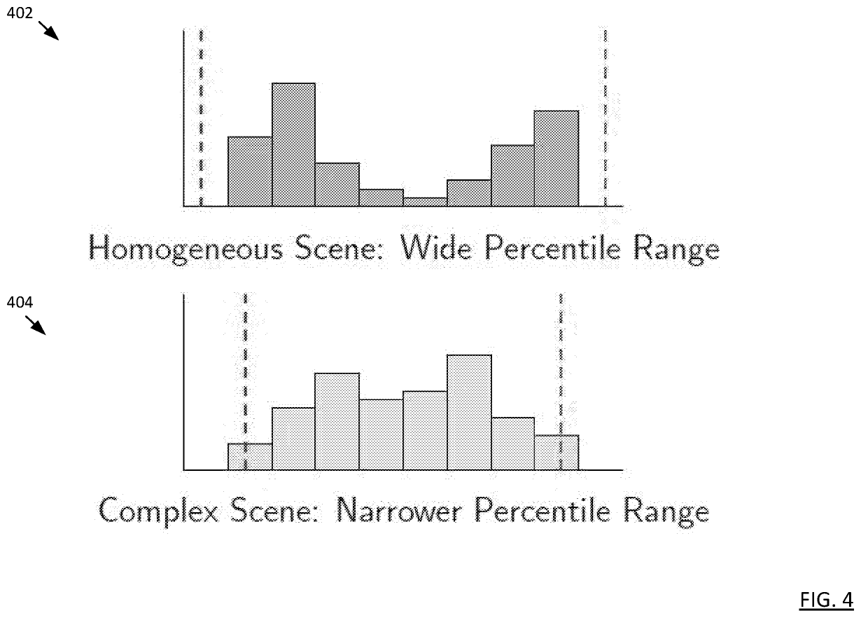

FIG. 4 illustrates percentile ranges and thresholds for example scenes with differing levels of complexity, according to an embodiment. Graph 402 illustrates the percentile range (P_{low} and p_{high}) representative of a relatively more homogenous, less complex scene. Because the homogenous scene does not have as much variation, no outliers are removed by the percentile thresholds. In contrast, graph 404 illustrates a percentile range representative of a relatively less homogenous, more complex scene. Because the more complex scene has more variation, percentile thresholds are calculated that result in outliers being subsequently identified and removed.

FIG. 5 illustrates a system block diagram of an HMD, according to an embodiment. The HMD 510 can be, for example, a display device, worn on the head or as part of a helmet that has a small display optic in front of one eye or each eye. In some embodiments, HMD 510 is a virtual reality (VR) headset that tracks three-dimensional (3D) position and rotation to provide a virtual environment to the user. Such a virtual reality headset of HMD 510 can be a three-degree of freedom (3DOF) VR headset for example having an inertial measurement unit (IMU) or a 6DOF VR headset for example using sensor fusion from multiple sensors/data sources including at least one IMU. Such an IMU and/or multiple sensors are shown in FIG. 5 as sensor(s) 511 of HMD 510. In addition to an IMU, sensor(s) 511 can include for example an accelerometer, a gyroscope, a camera, a red-green-blue (RGB) camera, a low light camera, a thermal camera, a WiFi® sensor (e.g., a WiFi® receiver or a WiFi® transceiver), a radar sensor, a magnetometer, etc. In some embodiments, HMD 510 is an AR or mixed reality (MR) device, such as a headset, glasses, goggles, etc. Similar to the VR headset, the AR or MR device can include one or more sensor(s) 511 that can track information regarding the user and/or an environment surrounding the user.

In some embodiments, the sensor(s) 511 can include imaging devices, such as, for example, an optical or infrared camera. In some embodiments, the imaging device can be a low light imaging camera (e.g., that uses high-sensitivity image sensors, that has larger sensors and/or individual pixels, have wider aperture lens like f/1.2 or f/1.4, etc.). The imaging devices can capture an environment around a user of HMD 510. For example, the imaging devices can capture an image feed or image data of a scene or environment around a user wearing the HMD 510, such as image 106A or 106B.

In some implementations, HMD 510 includes optical element(s) 514, which can be positioned in front of sensor(s) 511, such as a camera or other imaging device. Optical element(s) 514 can be configured to alter a line of sight or field of view of the camera in sensor(s) 511. For example, the optical element(s) 514 can be positioned in the line of sight of the camera and be configured to bend or redirect light to alter the field of view of the camera. Optical element(s) 514 can be configured to alter the field of view of the camera depending on the position or orientation of optical element(s) 514 relative to the camera. In some implementations, each optical element 514 can be configured to be adjusted in at least one degree of freedom (e.g., rotated about an axis) to refract or redirect light in a different direction. For example, an optical element from optical element(s) 514 can be rotatable about an axis corresponding to the line of sight of the camera. In some implementations, optical element(s) 514 can be rotated by about 45 degrees, about 90 degrees, about 135 degrees, or about 180 degrees. In some implementations, optical element 514 can be set to different positions or orientations to change the field of view of the camera. In some implementations, multiple cameras with independently adjustable optical element(s) 514 can be used to capture surfaces in multiple directions relative to the HMD 510. For example, two optical elements 514 can be set to different positions or orientations, to cause different cameras to capture different surfaces. In some implementations, optical element(s) 514 can include one or more multi-faceted prisms. In some implementations, the optical element(s) 514 can be adjustable by a user, e.g., by using their hands to manually rotate or move the optical elements 114 into set positions or orientations. Alternatively, or additionally, the optical element(s) 514 can be automatically adjusted, e.g., by a processor (e.g., processor 512) of the HMD 510. In some implementations, the optical element(s) 514 can be removable from the HMD 510, to enable a user to attach and/or detach the optical element(s) 514 when desired. For example, the optical element(s) 514 can be configured to be magnetically coupled to or mechanically fastened to the HMD 510, and be removable when desired. The optical element(s) 514 can be mostly removed from the HMD 510, and added to the HMD 510 when needed (or desired). In some implementations, optical element(s) 514 includes a mirror(s) configured to reflect light (e.g., from a scene to a camera, from a scene away from the camera, etc.). In some implementations, the mirror(s) can be oriented in a way such that light from an opaque surface is received at a camera of HMD 510 while light from all other surfaces and/or non-opaque surfaces is not received at the camera of HMD 510.

HMD 510 can also include a processor 512, a memory 513, a display 516, and a communications interface (not shown). Processor 512 can be coupled to sensor(s) 511, memory 513, display 516, and the communications interface. Processor 512 (e.g., a central processing unit (CPU), a graphics processing unit (GPU), and/or the like) can be, for example, a hardware-based integrated circuit (IC) or any other suitable processing device configured to run or execute a set of instructions or codes. In some embodiments, the processor 512 can execute instructions stored in memory 513 to perform one or more processes and/or functions, including processing sensor data (e.g., IMU data), performing method(s) 200, 600, 700, 800, etc. The memory 513 (e.g., a random-access memory (RAM), a hard drive, a flash drive, and/or the like) of HMD 510 can store data, and/or code that includes instructions to cause the processor 512 to perform one or more processes or functions. The communication interface (e.g., a network interface card (NIC), a Wi-Fi® transceiver, a Bluetooth® transceiver, and/or the like) can be a hardware component that facilitates data communication between HMD 510 and other devices (e.g., via network 140).

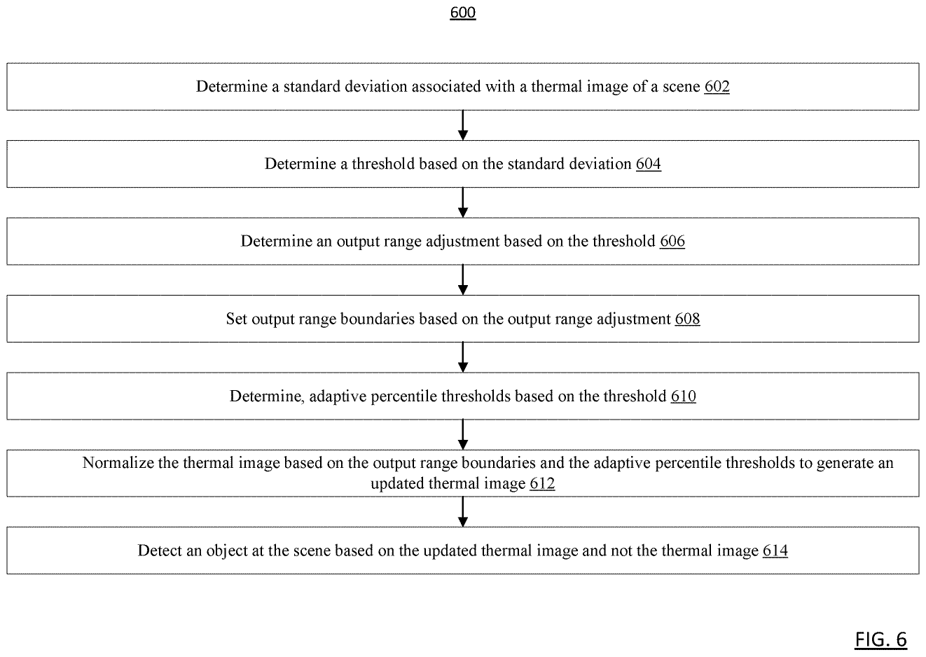

FIG. 6 illustrates a method 600 to generate an updated thermal image, according to an embodiment. In some implementations, method 600 is performed by a processor (e.g., processor 102 or 512).

At 602, a standard deviation associated with a thermal image (e.g., image 106A) of a scene is determined. At 604, a threshold is determined based on the standard deviation. At 606, an output range adjustment is determined based on the threshold. At 608, output range boundaries are set based on the output range adjustment. At 610, adaptive percentile thresholds are determined based on the threshold. At 612, the thermal image is normalized based on the output range boundaries and the adaptive percentile thresholds to generate an updated thermal image (e.g., updated image 108A). At 614, an object is detected at the scene based on the updated thermal image and not the thermal image. In some implementations, steps 604, 606, 608, 610, 612, and 614 occur automatically (e.g., without human intervention) in response to completing 602, 604, 606, 608, 610, and 612, respectively. In some implementations, method 600 can occur for any number of images to generate any number of updated images.

In some implementations, method 600 is performed by a processor that is included in a sensor (e.g., thermal camera). In some implementations, method 600 is performed by a processor that is included in an HMD (e.g., HMD 510).

In some implementations of method 600, the thermal image is a first thermal image, the scene is a first scene, the threshold is a first threshold, the output range adjustment is a first output range adjustment, the output range boundaries are first output range boundaries, the adaptive percentile thresholds are first adaptive percentile thresholds, and the updated thermal image is a first updated thermal image. A representation of a second thermal image (e.g., image 106B) of a second scene captured by the thermal camera is received. A standard deviation associated with the second thermal image is determined. A second threshold is determined based on the standard deviation associated with the second thermal image. A second output range adjustment is determined based on the second threshold. Second output range boundaries are set based on the second output range adjustment. Second adaptive percentile thresholds are determined based on the second threshold. The second thermal image is normalized based on the second output range boundaries and the second adaptive percentile thresholds to generate a second updated thermal image (e.g., updated image 108B). The first updated thermal image and the second updated thermal image are combined to generate a combined updated thermal image.

In some implementations of method 600, the thermal image includes an artifact and the updated thermal image does not include the artifact. In some implementations, an artifact refers to a visual distortion, inaccuracy, or anomaly introduced during thermal image capture, processing, or normalization that degrades the quality, interpretability, or accuracy of the thermal image. Examples of artifacts include, but are not limited to: brightness artifacts caused by outlier pixel values distorting normalization (e.g., a small number of extreme pixel values compressing the meaningful range of the image); saturation artifacts in which pixel values are saturated to a maximum or minimum value of an applicable color scale (e.g., whited out or blacked out regions in a grayscale palette); artificial brightness fluctuations in which the same object appears with varying brightness across frames due to temporal inconsistencies in normalization; thermal artifacts caused by anomalies in thermal data that result in false positive detections; and range compression artifacts in which sensitivity to extreme numerical values compresses the meaningful thermal range, thereby reducing local contrast and obscuring fine details.

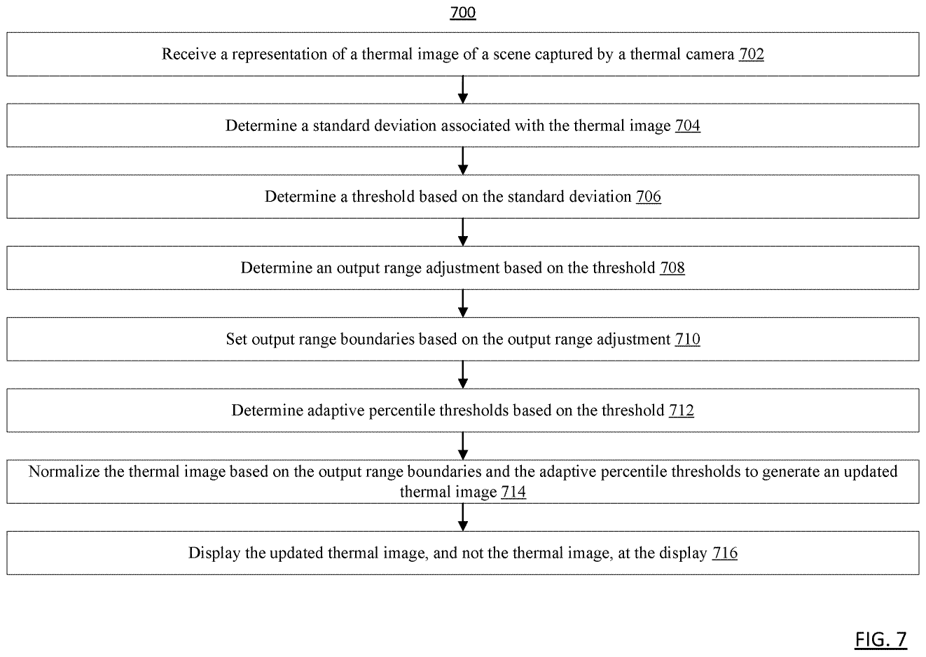

FIG. 7 illustrates a method 700 to display an updated thermal image, according to an embodiment. In some implementations, method 700 is performed by a processor (e.g., processor 102 or 512). In some implementations, the processor that performs method 700 is included in an HMD (e.g., HMD 510) that includes a display (e.g., display 516), a thermal camera (e.g., included in sensor(s) 511), and a memory (e.g., memory 513).

At 702, a representation of a thermal image (e.g., image 106A) of a scene captured by the thermal camera is received. At 704, a standard deviation associated with the thermal image is determined. At 706, a threshold is determined based on the standard deviation. At 708, an output range adjustment is determined based on the threshold. At 710, output range boundaries are set based on the output range adjustment. At 712, adaptive percentile thresholds are determined based on the threshold. At 714, the thermal image is normalized based on the output range boundaries and the adaptive percentile thresholds to generate an updated thermal image (e.g., update image 108A). At 716, the updated thermal image, and not the thermal image, are displayed at a display (e.g., display 516).

Some implementations of method 700 further include detecting, using a machine learning model, an object at the scene based on the updated thermal image and not the thermal image.

In some implementations of method 700, the thermal image includes an artifact and the updated thermal image does not include the artifact.

In some implementations of method 700, the thermal image is a first thermal image, the scene is a first scene, the threshold is a first threshold, the output range adjustment is a first output range adjustment, the output range boundaries are first output range boundaries, the adaptive percentile thresholds are first adaptive percentile thresholds, and the updated thermal image is a first updated thermal image. A representation of a second thermal image (e.g., image 106B) of a second scene captured by the thermal camera is received. A standard deviation associated with the second thermal image is determined. A second threshold is determined based on the standard deviation associated with the second thermal image. A second output range adjustment is determined based on the second threshold. Second output range boundaries are set based on the second output range adjustment. Second adaptive percentile thresholds are determined based on the second threshold. The second thermal image is normalized based on the second output range boundaries and the second adaptive percentile thresholds to generate a second updated thermal image (e.g., updated image 108B). The first updated thermal image and the second updated thermal image are combined to generate a combined updated thermal image.

In some implementations of method 700, the thermal image is a first thermal image, the scene is a first scene, the threshold is a first threshold, the output range adjustment is a first output range adjustment, the output range boundaries are first output range boundaries, the adaptive percentile thresholds are first adaptive percentile thresholds, and the updated thermal image is a first updated thermal image. Using a machine learning model, an object at the first updated thermal image is detected. A representation of a second thermal image (e.g., image 106B) of a second scene captured by the thermal camera is received. A standard deviation associated with the second thermal image is determined. A second threshold is determined based on the standard deviation associated with the second thermal image. A second output range adjustment is determined based on the second threshold. Second output range boundaries are set based on the second output range adjustment. Second adaptive percentile thresholds are determined based on the second threshold. The second thermal image is normalized based on the second output range boundaries and the second adaptive percentile thresholds to generate a second updated thermal image (e.g., updated image 108B). Using the machine learning model, the object is detected at the second updated thermal image. A brightness of the object at the first updated thermal image is substantially similar (e.g., within 1%, within 5%, within 10%, and/or the like) to a brightness of the object at the second updated thermal image.

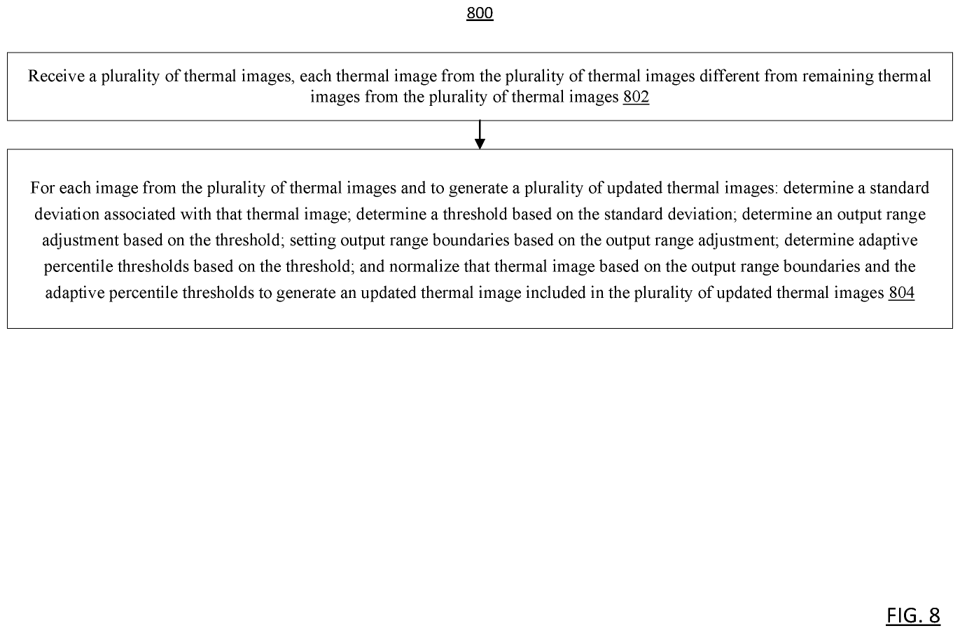

FIG. 8 illustrates a method 800 to generate updated thermal images, according to an embodiment. In some implementations, method 800 is performed by a processor (e.g., processor 102).

At 802, a plurality of thermal images (e.g., images 106A and 106B) is received. Each thermal image from the plurality of thermal images is different from remaining thermal images from the plurality of thermal images. At 804, to generate a plurality of updated thermal images (e.g., updated images 108A and 108B), for each image from the plurality of thermal images: a standard deviation associated with that thermal image is determined; a threshold is determined based on the standard deviation; an output range adjustment is determined based on the threshold; output range boundaries are set based on the output range adjustment; adaptive percentile thresholds are determined based on the threshold; and that thermal image is normalized based on the output range boundaries and the adaptive percentile thresholds to generate an updated thermal image included in the plurality of updated thermal images.

In some implementations of method 800, method 800 is performed by a processor included in a camera (e.g., camera 160), and the plurality of thermal images are captured by the camera.

Some implementations of method 800 further include detecting, using a machine learning model, at least one object based on the plurality of updated thermal images.

In some implementations of method 800, the plurality of thermal images include an artifact and the plurality of updated thermal images do not include the artifact.

Some implementations of method 800 further include combining the plurality of updated thermal images to generate a combined thermal image. An object at the combined thermal image can be detected using a machine learning model.

In some implementations of method 800, each thermal image from the plurality of thermal images includes an object, and a brightness of the object at the plurality of updated thermal images is substantially similar (e.g., within 1%, within 5%, within 10%, and/or the like) across the plurality of thermal images.

In some implementations of method 800, each thermal image from the plurality of thermal images is mutually exclusive from remaining thermal images from the plurality of thermal images.

In some implementations of method 800, each thermal image from the plurality of thermal images overlaps at least partially with at least one other thermal image from the plurality of thermal images.

Combinations of the foregoing concepts and additional concepts discussed here (provided such concepts are not mutually inconsistent) are contemplated as being part of the subject matter disclosed herein. The terminology explicitly employed herein that also may appear in any disclosure incorporated by reference should be accorded a meaning most consistent with the particular concepts disclosed herein.

The skilled artisan will understand that the drawings primarily are for illustrative purposes, and are not intended to limit the scope of the subject matter described herein. The drawings are not necessarily to scale; in some instances, various aspects of the subject matter disclosed herein may be shown exaggerated or enlarged in the drawings to facilitate an understanding of different features. In the drawings, like reference characters generally refer to like features (e.g., functionally similar and/or structurally similar elements).

To address various issues and advance the art, the entirety of this application (including the Cover Page, Title, Headings, Background, Summary, Brief Description of the Drawings, Detailed Description, Embodiments, Abstract, Figures, Appendices, and otherwise) shows, by way of illustration, various embodiments in which the embodiments may be practiced. As such, all examples and/or embodiments are deemed to be non-limiting throughout this disclosure.

It is to be understood that the logical and/or topological structure of any combination of any program components (a component collection), other components and/or any present feature sets as described in the Figures and/or throughout are not limited to a fixed operating order and/or arrangement, but rather, any disclosed order is an example and all equivalents, regardless of order, are contemplated by the disclosure.

Various concepts may be embodied as one or more methods, of which at least one example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments. Put differently, it is to be understood that such features may not necessarily be limited to a particular order of execution, but rather, any number of threads, processes, services, servers, and/or the like that may execute serially, asynchronously, concurrently, in parallel, simultaneously, synchronously, and/or the like in a manner consistent with the disclosure. As such, some of these features may be mutually contradictory, in that they cannot be simultaneously present in a single embodiment. Similarly, some features are applicable to one aspect of the innovations, and inapplicable to others.

The indefinite articles “a” and “an,” as used herein in the specification and in the embodiments, unless clearly indicated to the contrary, should be understood to mean “at least one.”

The phrase “and/or,” as used herein in the specification and in the embodiments, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used herein in the specification and in the embodiments, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the embodiments, “consisting of,” will refer to the inclusion of exactly one element of a number or list of elements. In general, the term “or” as used herein shall only be interpreted as indicating exclusive alternatives (i.e., “one or the other but not both”) when preceded by terms of exclusivity, such as “either,” “one of,” “only one of,” or “exactly one of.” “Consisting essentially of,” when used in the embodiments, shall have its ordinary meaning as used in the field of patent law.

As used herein in the specification and in the embodiments, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

In the embodiments, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures, Section 2111.03.

Some embodiments described herein relate to a computer storage product with a non-transitory computer-readable medium (also can be referred to as a non-transitory processor-readable medium) having instructions or computer code thereon for performing various computer-implemented operations. The computer-readable medium (or processor-readable medium) is non-transitory in the sense that it does not include transitory propagating signals per se (e.g., a propagating electromagnetic wave carrying information on a transmission medium such as space or a cable). The media and computer code (also can be referred to as code) may be those designed and constructed for the specific purpose or purposes. Examples of non-transitory computer-readable media include, but are not limited to, magnetic storage media such as hard disks, floppy disks, and magnetic tape; optical storage media such as Compact Disc/Digital Video Discs (CD/DVDs), Compact Disc-Read Only Memories (CD-ROMs), and holographic devices; magneto-optical storage media such as optical disks; carrier wave signal processing modules; and hardware devices that are specially configured to store and execute program code, such as Application-Specific Integrated Circuits (ASICs), Programmable Logic Devices (PLDs), Read-Only Memory (ROM) and Random-Access Memory (RAM) devices. Other embodiments described herein relate to a computer program product, which can include, for example, the instructions and/or computer code discussed herein.

Some embodiments and/or methods described herein can be performed by software (executed on hardware), hardware, or a combination thereof. Hardware modules may include, for example, a processor, a field programmable gate array (FPGA), and/or an application specific integrated circuit (ASIC). Software modules (executed on hardware) can include instructions stored in a memory that is operably coupled to a processor, and can be expressed in a variety of software languages (e.g., computer code), including C, C++, Java™, Ruby, Visual Basic™, and/or other object-oriented, procedural, or other programming language and development tools. Examples of computer code include, but are not limited to, micro-code or micro-instructions, machine instructions, such as produced by a compiler, code used to produce a web service, and files containing higher-level instructions that are executed by a computer using an interpreter. For example, embodiments may be implemented using imperative programming languages (e.g., C, Fortran, etc.), functional programming languages (Haskell, Erlang, etc.), logical programming languages (e.g., Prolog), object-oriented programming languages (e.g., Java, C++, etc.) or other suitable programming languages and/or development tools. Additional examples of computer code include, but are not limited to, control signals, encrypted code, and compressed code.

The terms “instructions” and “code” should be interpreted broadly to include any type of computer-readable statement(s). For example, the terms “instructions” and “code” may refer to one or more programs, routines, sub-routines, functions, procedures, etc. “Instructions” and “code” may include a single computer-readable statement or many computer-readable statements.

While specific embodiments of the present disclosure have been outlined above, many alternatives, modifications, and variations will be apparent to those skilled in the art. Accordingly, the embodiments set forth herein are intended to be illustrative, not limiting.

1. A helmet mounted display (HMD), comprising:
a display;
a thermal camera;
a memory; and
a processor operatively coupled to the display, the thermal camera, and the memory, the processor configured to:
receive a representation of a thermal image of a scene captured by the thermal camera;
determine a standard deviation associated with the thermal image;
determine a threshold based on the standard deviation;
determine an output range adjustment based on the threshold;
set output range boundaries based on the output range adjustment;
determine adaptive percentile thresholds based on the threshold;
normalize the thermal image based on the output range boundaries and the adaptive percentile thresholds to generate an updated thermal image; and
display the updated thermal image, and not the thermal image, at the display.

2. The HMD of claim 1, wherein the processor is further configured to:
detect, using a machine learning model, an object at the scene based on the updated thermal image and not the thermal image.

3. The HMD of claim 1, wherein the thermal image includes an artifact and the updated thermal image does not include the artifact.

4. The HMD of claim 1, wherein the thermal image is a first thermal image, the scene is a first scene, the threshold is a first threshold, the output range adjustment is a first output range adjustment, the output range boundaries are first output range boundaries, the adaptive percentile thresholds are first adaptive percentile thresholds, the updated thermal image is a first updated thermal image, and the processor is further configured to
receive a representation of a second thermal image of a second scene captured by the thermal camera;
determine a standard deviation associated with the second thermal image;
determine a second threshold based on the standard deviation associated with the second thermal image;
determine a second output range adjustment based on the second threshold;
set second output range boundaries based on the second output range adjustment;
determine second adaptive percentile thresholds based on the second threshold;
normalize the second thermal image based on the second output range boundaries and the second adaptive percentile thresholds to generate a second updated thermal image; and
combine the first updated thermal image and the second updated thermal image to generate a combined updated thermal image.

5. The HMD of claim 1, wherein the thermal image is a first thermal image, the scene is a first scene, the threshold is a first threshold, the output range adjustment is a first output range adjustment, the output range boundaries are first output range boundaries, the adaptive percentile thresholds are first adaptive percentile thresholds, the updated thermal image is a first updated thermal image, and the processor is further configured to:
detect, using a machine learning model, an object at the first updated thermal image;
receive a representation of a second thermal image of a second scene captured by the thermal camera;
determine a standard deviation associated with the second thermal image;
determine a second threshold based on the standard deviation associated with the second thermal image;
determine a second output range adjustment based on the second threshold;
set second output range boundaries based on the second output range adjustment;
determine second adaptive percentile thresholds based on the second threshold;
normalize the second thermal image based on the second output range boundaries and the second adaptive percentile thresholds to generate a second updated thermal image; and
detect, using the machine learning model, the object at the second updated thermal image, a brightness of the object at the first updated thermal image being substantially similar to a brightness of the object at the second updated thermal image.

6. A method, comprising:
determining, by a processor, a standard deviation associated with a thermal image of a scene;
determining, by the processor, a threshold based on the standard deviation;
determining, by the processor, an output range adjustment based on the threshold;
setting, by the processor, output range boundaries based on the output range adjustment;
determining, by the processor, adaptive percentile thresholds based on the threshold;
normalizing, by the processor, the thermal image based on the output range boundaries and the adaptive percentile thresholds to generate an updated thermal image; and
detecting, by the processor, an object at the scene based on the updated thermal image and not the thermal image.

7. The method of claim 6, wherein the processor is included in a sensor.

8. The method of claim 7, wherein the sensor is a thermal camera.

9. The method of claim 6, wherein the processor is included in a helmet mounted display.

10. The method of claim 6, wherein the thermal image is a first thermal image, the scene is a first scene, the threshold is a first threshold, the output range adjustment is a first output range adjustment, the output range boundaries are first output range boundaries, the adaptive percentile thresholds are first adaptive percentile thresholds, the updated thermal image is a first updated thermal image, and the method further comprising:
receiving a representation of a second thermal image of a second scene captured by the thermal camera;
determining a standard deviation associated with the second thermal image;
determining a second threshold based on the standard deviation associated with the second thermal image;
determining a second output range adjustment based on the second threshold;
setting second output range boundaries based on the second output range adjustment;
determining second adaptive percentile thresholds based on the second threshold;
normalizing the second thermal image based on the second output range boundaries and the second adaptive percentile thresholds to generate a second updated thermal image; and
combining the first updated thermal image and the second updated thermal image to generate a combined updated thermal image.

11. The method of claim 6, wherein the thermal image includes an artifact and the updated thermal image does not include the artifact.

12. A non-transitory, processor readable medium storing instructions that, when executed by one or more processors, cause the one or more processors to:
receive a plurality of thermal images, each thermal image from the plurality of thermal images different from remaining thermal images from the plurality of thermal images;
for each image from the plurality of thermal images and to generate a plurality of updated thermal images:
determine a standard deviation associated with that thermal image;
determine a threshold based on the standard deviation;
determine an output range adjustment based on the threshold;
setting output range boundaries based on the output range adjustment;
determine adaptive percentile thresholds based on the threshold; and
normalize that thermal image based on the output range boundaries and the adaptive percentile thresholds to generate an updated thermal image included in the plurality of updated thermal images.

13. The non-transitory, processor readable medium of claim 12, wherein one or more processors are included in a camera, and the plurality of thermal images are captured by the camera.

14. The non-transitory, processor readable medium of claim 12, wherein the non-transitory, processor-readable medium further stores instructions that, when executed by the one or more processors, cause the one or more processors to:
detect, using a machine learning model, at least one object based on the plurality of updated thermal images.

15. The non-transitory, processor readable medium of claim 12, wherein the plurality of thermal images includes an artifact and the plurality of updated thermal images do not include the artifact.

16. The non-transitory, processor readable medium of claim 12, wherein the non-transitory, processor-readable medium further stores instructions that, when executed by the one or more processors, cause the one or more processors to:
combine the plurality of updated thermal images to generate a combined thermal image.

17. The non-transitory, processor readable medium of claim 12, wherein the non-transitory, processor-readable medium further stores instructions that, when executed by the one or more processors, cause the one or more processors to:
combine the plurality of updated thermal images to generate a combined thermal image; and
detect, using a machine learning model, an object at the combined thermal image.

18. The non-transitory, processor readable medium of claim 12, wherein each thermal image from the plurality of thermal images includes an object, and a brightness of the object at the plurality of thermal images is substantially similar across the plurality of thermal images.

19. The non-transitory, processor readable medium of claim 12, wherein each thermal image from the plurality of thermal images is mutually exclusive from remaining thermal images from the plurality of thermal images.

20. The non-transitory, processor readable medium of claim 12, wherein each thermal image from the plurality of thermal images overlaps at least partially with at least one other thermal image from the plurality of thermal images.
